(19) United States
(12) Patent Application Publication
(10) Pub. No.: US 2016/0236438 A1
(43) Pub. Date: Aug. 18, 2016

(54) DEVICE AND METHOD FOR PREVENTING WARPING OF DOUBLE-FACED CORRUGATED CARDBOARD SHEET AND MANUFACTURING APPARATUS FOR DOUBLE-FACED CORRUGATED CARDBOARD SHEET

(71) Applicant: MITSUBISHI HEAVY INDUSTRIES PRINTING & PACKAGING MACHINERY, LTD., Mihara-shi, Hiroshima (JP)

(72) Inventors: Takashi NITTA, Mihara-shi, Hiroshima (JP); Hideki MIZUTANI, Mihara-shi, Hiroshima (JP); Hirofumi SUGIMURA, London (GB)

(21) Appl. No.: 15/024,841

(22) PCT Filed: Jul. 30, 2014
(86) PCT No.: PCT/JP2014/070125

§ 371 Date: Mar. 24, 2016

(30) Foreign Application Priority Data
Nov. 1, 2013 (JP) 2013-228663

(51) Int. Cl. B31F 1/28

(52) U.S. Cl. CPC B31F 1/284; B31F 1/285

(57) ABSTRACT

A device for preventing warping of double-faced corrugated cardboard sheets has a conveyance section for bringing a belt into contact with the upper surface of a single-faced corrugated cardboard sheet while moving the belt in a specified direction when manufacturing a double-faced corrugated cardboard sheet by gluing the single-faced corrugated cardboard sheet, which is obtained from a corrugated medium and a single facer side liner, to a double facer side liner; a heating section below the conveyance section for contacting the lower surface of the double facer side liner; multiple pressing units for applying pressing forces toward the heating section through the belt; and a control unit for controlling the pressing units so that the assignment of pressing forces in the width direction differs between the upstream side and the downstream side of the belt movement direction.

### TECHNICAL FIELD

The present invention relates to a device and a method for preventing warping of double-faced corrugated cardboard sheets that prevents warping of double-faced corrugated cardboard sheets when forming a double-faced corrugated cardboard sheet by gluing liners to both surfaces of a corrugated medium subjected to waveform processing, and a manufacturing apparatus for double-faced corrugated cardboard sheets.

### BACKGROUND ART

Corrugating machines as manufacturing apparatuses for double-faced corrugated cardboard sheets include a single facer that forms a single-faced corrugated cardboard sheet, and a double facer that forms a double-faced corrugated cardboard sheet by gluing a double facer side liner to the single-faced corrugated cardboard sheet. The single facer performs waveform processing of corrugated paper (corrugated medium) supplied from a mill roll stand, and glues a single facer side liner supplied from another mill roll stand to form a single-faced corrugated cardboard sheet. The single-faced corrugated cardboard sheet formed by the single facer is sent to a bridge provided on the downstream side, and is sent to the double facer on the downstream side in accordance with the speed of the double facer while being stored in the bridge. The double facer forms a double-faced corrugated cardboard sheet by gluing a double facer side liner, which is sent from a separately provided mill roll stand, to the single-faced corrugated cardboard sheet sent from the bridge. After specified slits or specified ruled lines are formed in a conveying direction by slitter scorers in the double-faced corrugated cardboard sheet that has passed through this double facer, the double-faced corrugated cardboard sheet is cut into a corrugated cardboard sheet in the width direction by a cutter device, and the cut corrugated cardboard sheets are stacked on a stacker and are discharged sequentially.

In the double facer of this corrugating machine, generally, a belt conveyor is arranged in an upper part of a conveying path for transporting the single-faced corrugated cardboard sheet and the double facer side liner in a state where the single-faced corrugated cardboard sheet and the double facer side liner are superimposed on each other, a heating section is arranged at a lower part of the conveying path, and a pressing unit that presses a belt toward the heating section is arranged above the belt of the belt conveyor.

In the related art, for example, a corrugating machine described in PTL 1 prevents warping that occurs immediately after manufacture of a double-faced corrugated cardboard sheet. Here, since the warping occurs due to a difference being caused in the amount of moisture included in a double facer side liner and the amount of moisture included in a single facer side liner, it is shown that the warping is preventing by supplying moisture appropriately.

Additionally, for example, a warping correction system for corrugated cardboard sheets described in PTL 2 prevents twist warping that occurs in double-faced corrugated cardboard sheets. It is shown that, since twist warping occurs when a tension distribution becomes a distribution having a bias in a width direction in a case where a direction indicated by fibers forming a sheet is inclined with respect to a sheet conveying direction even if the tension distribution along a sheet width direction is uniform, pressing forces vary with respect to the sheet width direction.

Additionally, for example, in the control of an adjustment type ballast system in a double facer described in PTL 3, it is shown that it is desirable to provide certain means for transversely changing a vertical ballast load applied to a hold-down belt longitudinally in a movement direction of a belt and a web in the double facer and over the entire width of the belt and the web, for several reasons.

### CITATION LIST

### Patent Literature

[PTL 1] Japanese Patent No. 3457919

[PTL 2] Japanese Unexamined Patent Application Publication No. 2003-266568

[PTL 3] Japanese Unexamined Patent Application Publication No. 8-109590

### SUMMARY OF INVENTION

### Technical Problem

Meanwhile, warping may occur in double-faced corrugated cardboard sheets, and for example, as described in PTL 1, the warping occurs due to a difference being caused in the amount of moisture included in the double facer side liner and the amount of moisture included in the single facer side liner. In PTL 1, the warping occurs because there is a difference in the amount of moisture caused by painting, but the warping occurs irrespective of the painting. The reasons for a difference in the amount of moisture being caused other than such painting have not been elucidated, and it is the present situation that the warping cannot be effectively prevented.

The present inventors have invented a new technique for elucidating reasons for a difference in the amount of moisture being caused and effectively preventing warping in a double facer in which a belt conveyor is arranged in an upper part of the conveying path for transporting a single-faced corrugated cardboard sheet and a double facer side liner in a state where the single-faced corrugated cardboard sheet and a double facer side liner are superimposed on each other, a heating section is arranged at the lower part of the conveying path, and a pressing unit that presses a belt toward the heating section is arranged above the belt of the belt conveyor.

An object of the invention is to provide a device and a method for preventing warping of double-faced corrugated cardboard sheets that can effectively prevent warping that occurs in double-faced corrugated cardboard sheets, and a manufacturing apparatus for double-faced corrugated cardboard sheets.

### Solution to Problem

In order to achieve the above-described object, a device for preventing warping of doubled-faced corrugated cardboard sheets of the invention includes a conveyance section for moving a belt in a specified direction while bringing the belt into contact with an upper surface of a single-faced corrugated cardboard sheet when manufacturing a double-faced corrugated cardboard sheet by gluing the single-faced corrugated cardboard sheet including a corrugated medium and a second liner to a first liner; a heating section that is provided below the conveyance section and contacts a lower surface of the first liner; a pressing unit having a plurality of pressing mechanism parts that are disposed in a movement direction of the belt and a width direction orthogonal to the movement direction and apply pressing forces toward the heating section via the belt of the conveyance section; and a control unit that controls the respective pressing mechanism parts of the pressing unit so that the pressing forces in the width direction are differently assigned on an upstream side and a downstream side in the movement direction of the belt.

It has been elucidated by the inventors' verification that the forms of warping exerted on the single-faced corrugated cardboard sheet and the first liner, respectively, in the double-faced corrugated cardboard sheet, are made reverse to each other on the upstream side and the downstream side in the movement direction of the belt. According to the device for preventing warping of double-faced corrugated cardboard sheets, with respect to the warping forms of the double-faced corrugated cardboard sheet, warping that occurs in the double-faced corrugated cardboard sheet can be effectively prevented by controlling the respective pressing mechanism parts in the control unit so as to provide pressing patterns such that occurrence of warping of the single-faced corrugated cardboard sheet and the first liner is prevented on the upstream side and the downstream side, respectively, in the movement direction of the belt.

Additionally, the device for preventing warping of double-faced corrugated cardboard sheets further includes a warping information acquisition unit that acquires warping information including a warping form in the width direction of the double-faced corrugated cardboard sheet or an element resulting from the warping form. The control unit controls the respective pressing mechanism parts of the pressing unit, on the basis of the warping information input from the warping information acquisition unit.

According to the device for preventing warping of double-faced corrugated cardboard sheets, warping that occurs in the double-faced corrugated cardboard sheet can be more effectively prevented by inputting the warping information including the warping form or the element resulting from the warping form to the control unit.

In order to achieve the above-described object, a method for preventing warping of double-faced corrugated cardboard sheets includes a conveying step of moving a belt in a specified direction while bringing the belt into contact with an upper surface of a single-faced corrugated cardboard sheet when manufacturing a double-faced corrugated cardboard sheet by gluing the single-faced corrugated cardboard sheet including a corrugated medium and a second liner, to a first liner; a heating step of performing heating from a lower surface side of the first liner of the double-faced corrugated cardboard sheet moved by the conveying step; and a pressing step of applying pressing forces to the double-faced corrugated cardboard sheet moved by the conveying step from the single-faced corrugated cardboard sheet side via the belt, and making assignment of the pressing forces in the width direction different on an upstream side and a downstream side in the movement direction of the belt.

It has been elucidated by the inventors' verification that the forms of warping exerted on the single-faced corrugated cardboard sheet and the first liner, respectively, in the double-faced corrugated cardboard sheet, are made reverse to each other on the upstream side and the downstream side in the movement direction of the belt. According to the method for preventing warping of double-faced corrugated cardboard sheets, with respect to the warping forms of the double-faced corrugated cardboard sheet, warping that occurs in the double-faced corrugated cardboard sheet can be effectively prevented by providing pressing patterns such that occurrence of warping of the single-faced corrugated cardboard sheet and the first liner is prevented on the upstream side and the downstream side, respectively, in the movement direction of the belt.

Additionally, in the method for preventing warping of double-faced corrugated cardboard sheets of the invention, the assignment positions of the pressing forces in the width direction are made reverse to each other on the upstream side and the downstream side in the movement direction of the belt in the pressing step.

According to the method for preventing warping of double-faced corrugated cardboard sheets, for example, in a case where warping is exerted on both of the single-faced corrugated cardboard sheet and the first liner, the assignment positions of the pressing forces in the width direction are made reverse to each other on the upstream side and the downstream side in the movement direction of the belt, so that both kinds of warping can be suppressed and warping that occurs in the double-faced corrugated cardboard sheet can be effectively prevented.

Additionally, in the method for preventing warping of double-faced corrugated cardboard sheets of the invention, in the pressing step, the pressing forces in the width direction may be made different on the upstream side in the movement direction of the belt and the pressing forces in the width direction on the downstream side may be made constant.

According to the method for preventing warping of double-faced corrugated cardboard sheets, for example, in a case where the amount of warping is relatively small and warping is markedly exerted on one of the single-faced corrugated cardboard sheet and the first liner, the pressing forces in the width direction are made different on the upstream side in the movement direction of the belt and the pressing forces in the width direction are made constant on the downstream side, so that warping that is markedly exerted can be suppressed and warping that occurs in the double-faced corrugated cardboard sheet can be effectively prevented.

Additionally, in the method for preventing warping of double-faced corrugated cardboard sheets of the invention, in the pressing step, the pressing forces in the width direction may be made different on the downstream side in the movement direction of the belt and the pressing forces in the width direction on the upstream side may be made constant.

According to the method for preventing warping of double-faced corrugated cardboard sheets, for example, in a case where the amount of warping is relatively small and warping is markedly exerted on one of the single-faced corrugated cardboard sheet and the first liner, the pressing forces in the width direction are made different on the upstream side in the movement direction of the belt and the pressing forces in the width direction are made constant on the downstream side, so that warping that is markedly exerted can be suppressed and warping that occurs in the double-faced corrugated cardboard sheet can be effectively prevented.

Additionally, in the method for preventing warping of double-faced corrugated cardboard sheets of the invention, in the pressing step, the warping information including the warping form in the width direction of the double-faced corrugated cardboard sheet or the element resulting from the warping form is acquired, and the pressing forces are applied on the basis of the warping information.

According to the method for preventing warping of double-faced corrugated cardboard sheets, warping that occurs in the double-faced corrugated cardboard sheet can be more effectively prevented by acquiring the warping information including the warping form or the element resulting from the warping form.

In order to achieve the above-described object, the manufacturing apparatus for double-faced corrugated cardboard sheets is a manufacturing apparatus for double-faced corrugated cardboard sheets that glues a second liner to a corrugated medium to form a single-faced corrugated cardboard sheet, and subsequently, glues the first liner to the corrugated medium in the single-faced corrugated cardboard sheet to a form double-faced corrugated cardboard sheet. The above-described device for preventing warping of double-faced corrugated cardboard sheets is applied in a case where the first liner in the single-faced corrugated cardboard sheet is glued to the corrugated medium.

According to the manufacturing apparatus of double-faced corrugated cardboard sheets, with respect to the warping forms of the double-faced corrugated cardboard sheet, warping that occurs in the double-faced corrugated cardboard sheet can be effectively prevented by controlling the respective pressing mechanism parts in the control unit so as to provide pressing patterns such that occurrence of warping of the single-faced corrugated cardboard sheet and the first liner is prevented on the upstream side and the downstream side, respectively, in the movement direction of the belt. As a result, the number of defects in which the double-faced corrugated cardboard sheet is warped can be reduced.

### Advantageous Effects of Invention

According to the invention, warping that occurs in double-faced corrugated cardboard sheets can be effectively prevented.

### BRIEF DESCRIPTION OF DRAWINGS

FIG. 1 is a schematic view illustrating a corrugating machine as a manufacturing apparatus for double-faced corrugated cardboard sheets related to an embodiment of the invention.

FIG. 2 is a side view illustrating a double facer including a device for preventing warping of double-faced corrugated cardboard sheets related to the embodiment of the invention.

FIG. 3 is a side view illustrating the device for preventing warping of double-faced corrugated cardboard sheets related to the embodiment of the invention.

FIG. 4 is a plan sectional view illustrating the device for preventing warping of double-faced corrugated cardboard sheets related to the embodiment of the invention.

FIG. 5 is a graph illustrating pressing patterns obtained by the device for preventing warping of double-faced corrugated cardboard sheets related to the embodiment of the invention.

### DESCRIPTION OF EMBODIMENTS

Preferred embodiments of the invention will be described below in detail with reference to the accompanying drawings. In addition, the invention is not limited by the embodiments and includes those configured by combining respective embodiments in a case where there are a plurality of embodiments.

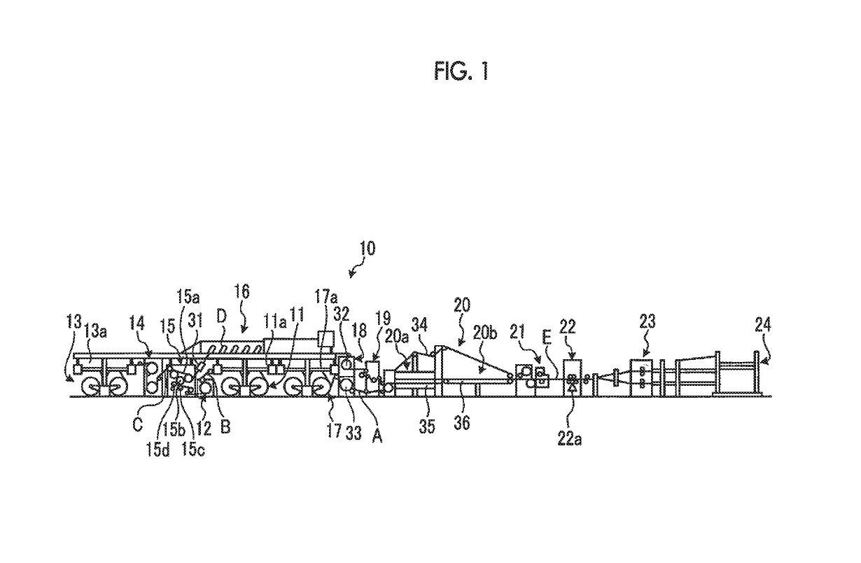

FIG. 1 is a schematic view illustrating a corrugating machine as a manufacturing apparatus for corrugated cardboard sheets related to an embodiment of the invention.

As illustrated in FIG. 1, a corrugating machine 10 as a manufacturing apparatus for double-faced corrugated cardboard sheets manufactures a single-faced corrugated cardboard sheet D by gluing a single facer side liner C as a second liner, for example, a web before forming a double-faced corrugated cardboard sheet to a corrugated medium (corrugated paper) B subjected to waveform processing as a web before forming the double-faced corrugated cardboard sheet, and manufactures a double-faced corrugated cardboard sheet E by gluing a double facer side liner A as a first liner, for example, as a web before forming the double-faced corrugated cardboard sheet to the corrugated medium B side in the manufactured single-faced corrugated cardboard sheet D.

The corrugating machine 10 has a mill roll stand 11 for the corrugated medium B, a preheater (preheating device) 12, a mill roll stand 13 for the single facer side liner C, a preheater (preheating device) 14, a single facer 15, a bridge 16, a mill roll stand 17 for the double facer side liner A, a preheater (preheating device) 18, a glue machine 19, a double facer 20, a rotary shear 21, a slitter scorer 22, a cutter 23, and a stacker 24.

The mill roll stand 11 has rolled paper, around which corrugated paper formed with the corrugated medium B is wound in the shape of a roll, mounted on both sides thereof, respectively, and a splicer (paper splicing device) 11a that performs paper splicing is provided above the mill roll stand. In a case where paper is fed from one rolled paper, the other rolled paper is mounted and paper splicing is prepared. If base paper of the one rolled paper runs short, this base paper of the one roller paper is spliced to base paper of the other rolled paper by the splicer 11a. While the base paper is supplied from the other rolled paper, the one rolled paper is mounted and paper splicing is prepared. The base paper is sequentially spliced in this way, and is continuously delivered from the mill roll stand 11 toward the downstream side.

The mill roll stand 13 has rolled paper, around which the single facer side liner C is wound in the shape of a roll, mounted on both sides thereof, respectively, and a splicer 13a that performs paper splicing is provided above the mill roll stand. In a case where paper is fed from one rolled paper, the other rolled paper is mounted and paper splicing is prepared. If base paper of the one rolled paper runs short, this base paper of the one roller paper is spliced to base paper of the other rolled paper by the splicer 13a. While the base paper is supplied from the other rolled paper, the one rolled paper is mounted and paper splicing is prepared. The base paper is sequentially spliced in this way, and is continuously delivered from the mill roll stand 13 toward the downstream side.

The respective preheaters 12 and 14 preheat the corrugated medium B and the single facer side liner C, respectively. The respective preheaters 12 and 14 have therein heating rolls to which steam is supplied, the base paper (the corrugated medium B and the single facer side liner C) continuously delivered from the mill roll stands 11 and 13 is wound around the heating rolls and conveyed, thereby raising the temperature of the base paper to a specified temperature.

The single facer 15 has a pressing belt 15a, an upper stage roll 15b, and a lower stage roll 15c. The single facer side liner C heated by the preheater 14 is transferred to a nip part between the pressing belt 15a and the upper stage roll 15b. Meanwhile, the corrugated medium B heated by the preheater 12 is subjected to waveform processing in an engagement part between the upper stage roll 15b and the lower stage roll 15c, and then transferred to the nip part between the pressing belt 15a and the upper stage roll 15b. A glue application device 15d is arranged in the vicinity of the upper stage roll 15b. The corrugated medium B corrugated in the engagement part between the upper stage roll 15b and the lower stage roll 15c is glue-applied to respective wave-like apexes by the glue application device 15d, is glued to the single facer side liner C in the nip part between the pressing belt 15a and the upper stage roll 15b, whereby the single-faced corrugated cardboard sheet D is formed.

A take-up conveyor 31 is provided obliquely upward on the downstream side in the conveying direction of the single facer 15. The take-up conveyor 31 is constituted of a pair of endless belts, and has a function of sandwiching this single-faced corrugated cardboard sheet D formed in the single facer 15 to convey the sheet to the bridge 16. The bridge 16 functions as a stay unit that primarily stays the single-faced corrugated cardboard sheet D in order to absorb a speed difference between the single facer 15 and the double facer 20.

The mill roll stand 17 has rolled paper, around which the double facer side liner A is wound in the shape of a roll, mounted on both sides thereof, respectively, and a splicer 17a that performs paper splicing is provided above the mill roll stand. In a case where paper is fed from one rolled paper, the other rolled paper is mounted and paper splicing is prepared. If base paper of the one rolled paper runs short, this base paper of the one roller paper is spliced to base paper of the other rolled paper by the splicer 17a. While the base paper is supplied from the other rolled paper, the one rolled paper is mounted and paper splicing is prepared. The base paper is sequentially spliced in this way, and is continuously delivered from the mill roll stand 17 toward the downstream side.

The preheater 18 has a heating roll 32 for the single-faced corrugated cardboard sheet D (hereinafter referred to as a single corrugated sheet heating roll), and a heating roll 33 for the double facer side liner A (hereinafter referred to as a double facer side liner heating roll). The single corrugated sheet heating roll 32 has a winding amount adjusting device, is heated to a specified temperature by steam being supplied to the inside thereof, and is able to preheat the single-faced corrugated cardboard sheet D by the single facer side liner C side of the single-faced corrugated cardboard sheet D being wound around a peripheral surface thereof. Meanwhile, similarly, the double facer side liner heating roll 33 also has a winding amount adjusting device, is heated to a specified temperature by steam being supplied to the inside thereof, and is able to preheat the double facer side liner A by the double facer side liner A being wound around a peripheral surface thereof.

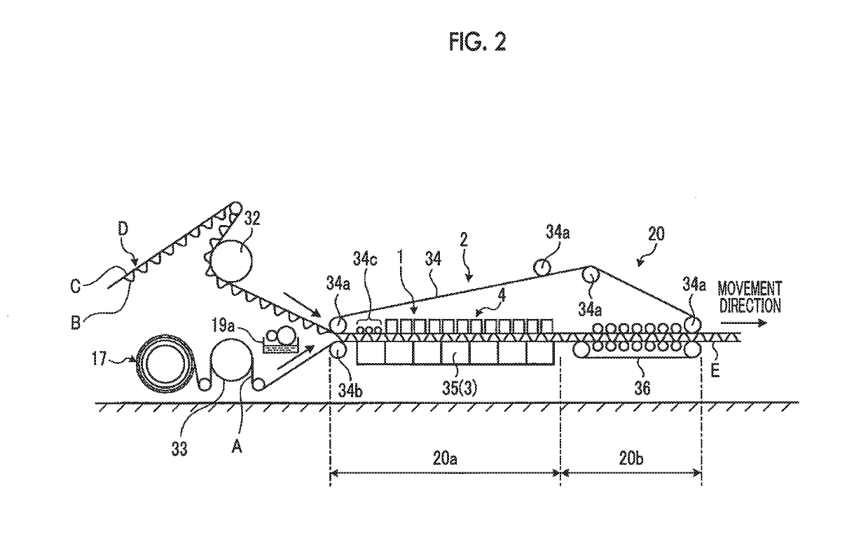

The glue machine 19 has a glue application device 19a (refer to FIG. 2). The single-faced corrugated cardboard sheet D heated by the single corrugated sheet heating roll 32 is guided into the glue machine 19 on the way, and when the sheet passes between a rider roll and a glue application roll, glue is applied to respective apexes of the corrugations of the corrugated medium B.

The single-faced corrugated cardboard sheet D to which glue is applied by the glue machine 19 is transferred to the double facer 20 in the following step. Additionally, the double facer side liner A heated by the double facer side liner heating roll 33 is also transferred to the double facer 20 through the glue machine 19.

The double facer 20 is divided into an upstream heating section 20a and a downstream cooling section 20b along a traveling line for the single-faced corrugated cardboard sheet D and the double facer side liner A. The single-faced corrugated cardboard sheet D to which glue is applied by the glue machine 19 is carried in between a belt 34 and a heating plate 35 by the heating section 20a. Meanwhile, the double facer side liner A is carried in between the belt 34 and the heating plate 35 so as to overlap the corrugated medium B side of the single-faced corrugated cardboard sheet D. Then, the single-faced corrugated cardboard sheet D and the double facer side liner A are carried in between the belt 34 and the heating plate 35, and are then integrated in a vertically overlapping state and transferred toward the cooling section 20b. During this transfer, the single-faced corrugated cardboard sheet D and the double facer side liner A are heated while being pressed, and are thereby glued to each other, thereby forming the double-faced corrugated cardboard sheet E. The double-faced corrugated cardboard sheet E is naturally cooled in the cooling section 20b when being conveyed while being sandwiched between the belt 34 and the conveying belt 36.

The double-faced corrugated cardboard sheet E manufactured by the double facer 20 is transferred to the rotary shear 21. The rotary shear 21 cuts the double-faced corrugated cardboard sheet E over the full width or partially in a width direction.

The slitter scorer 22 cuts the double-faced corrugated cardboard sheet E with a specified cutting width dimension in a conveying direction, and processes ruled lines that extend in the conveying direction. The slitter scorer 22 has a plurality of sets, each including an upper ruled line roll and a lower ruled line roll that are disposed to face each other with the double-faced corrugated cardboard sheet E sandwiched therebetween, in the width direction, and has a plurality of sets of slitter knives, which are disposed below the double-faced corrugated cardboard sheet E, in the width direction.

The cutter 23 cuts the double-faced corrugated cardboard sheet E, which is cut in the conveying direction by the slitter scorer 22, in the width direction, and forms the sheet in the shape of a plate. The cutter 23 receives and processes two double-faced corrugated cardboard sheets E, which are cut with a specified width along the conveying direction in the slitter scorer 22, in two upper and lower stages, and both the sheets have substantially the same configuration. The stacker 24 stacks the double-faced corrugated cardboard sheets E cut by the cutter 23, and discharges the sheets to the outside of the device as products.

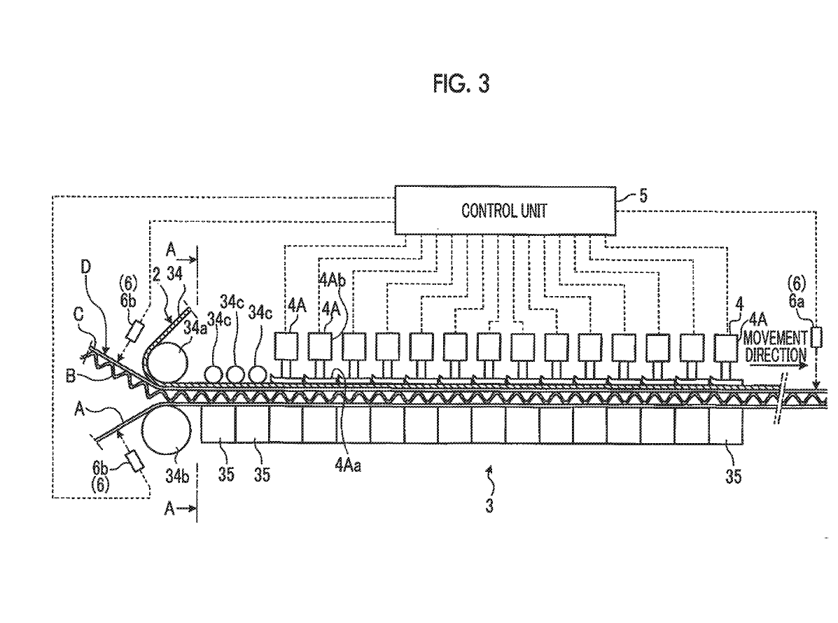

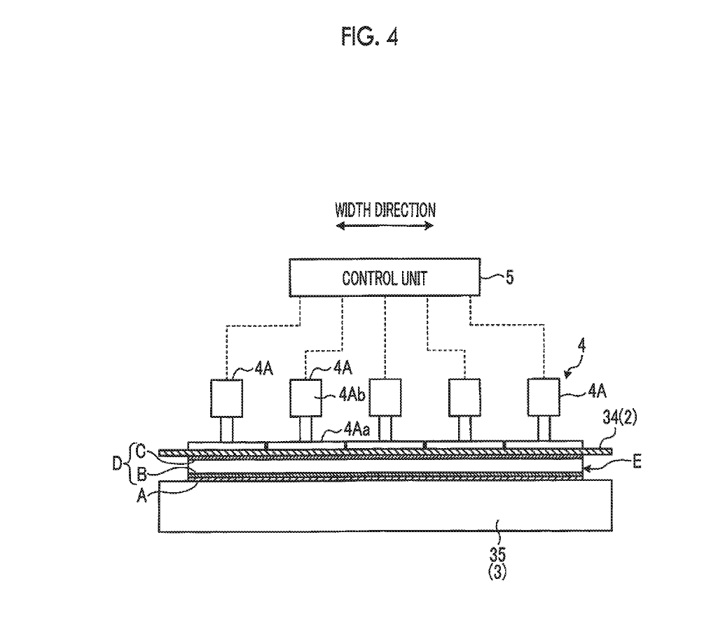

Hereinafter, the device for preventing warping of double-faced corrugated cardboard sheets related to the present embodiment will be described. FIG. 2 is a side view illustrating the double facer including the device for preventing warping of double-faced corrugated cardboard sheets related to the present embodiment, FIG. 3 is a side view illustrating the device for preventing warping of double-faced corrugated cardboard sheets related to the present embodiment, and FIG. 4 is a plan sectional view illustrating the device for preventing warping of double-faced corrugated cardboard sheets related to the present embodiment. In addition, FIG. 4 illustrates a section as viewed from arrow A-A of FIG. 3.

A device 1 for preventing warping of double-faced corrugated cardboard sheets of the present embodiment is provided in the above-described double facer 20. The double facer 20 is configured so as to be divided into an upstream heating section 20a and a downstream cooling section 20b, as described above with reference to FIG. 2. The heating section 20a forms the double-faced corrugated cardboard sheet E by bonding the single-faced corrugated cardboard sheet D heated by the single corrugated sheet heating roll 32 and glue-applied by the glue application device 19a and the double facer side liner A heated by the double facer side liner heating roll 33 together. The device 1 for preventing warping of double-faced corrugated cardboard sheets of the present embodiment is included in the heating section 20a.

The device 1 for preventing warping of double-faced corrugated cardboard sheets, as illustrated in FIGS. 2 to 4, includes a conveyance section 2, a heating section 3, a pressing unit 4, and a control unit 5 (refer to FIGS. 3 and 4).

The conveyance section 2 has the above-described belt 34. The belt 34 is an endless belt that has a larger width than the width of the double-faced corrugated cardboard sheet E and is wound around a plurality of rollers 34a, and a lower side portion thereof contacts an upper surface (single facer side liner C side) of the single-faced corrugated cardboard sheet D. The belt 34 has tension applied thereto by the respective rollers 34a, and the lower side portion thereof, which contacts the upper surface of the single-faced corrugated cardboard sheet D, is moved in a movement direction indicated by an arrow in FIGS. 2 and 3 by rotation of at least one roller 34a. Additionally, in the conveyance section 2, a roller 34a is provided at an inlet portion where the single-faced corrugated cardboard sheet D and the double facer side liner A are carried into the heating section 20a, a roller 34b that contacts the double facer side liner A is provided below the roller 34a. As the single-faced corrugated cardboard sheet D contacts the single facer side liner C side along the belt 34 wound around the roller 34a at the inlet portion of the conveyance section 2, and a pressing force is applied thereto by the pressing unit 4, a pulling force acts in a rotational direction of the belt 34, and consequently, tension is applied to the single-faced corrugated cardboard sheet D. Meanwhile, a pulling force acts on the double facer side liner A in the rotational direction of the belt 34 via the single-faced corrugated cardboard sheet D, and consequently, tension is applied to the double facer side liner A. Additionally, in the conveyance section 2, a roller 34c is provided in a portion on the downstream side of the roller 34a at the inlet portion and on the upstream side of the pressing unit 4. The roller 34c extends in the width direction of the double-faced corrugated cardboard sheet E, and a plurality of (three in the present embodiment) the rollers 34c are provided along the rotational direction of the belt 34. The rollers 34c apply stronger pressing forces linearly in the width direction of the double-faced corrugated cardboard sheet E with respect to the pressing in a surface by the pressing unit 4.

The heating section 3 is constituted of the above-described heating plate 35. As illustrated in FIGS. 2 and 3, the heating plate 35 is provided with a gap allowing passage of the double-faced corrugated cardboard sheet E in which the double facer side liner A is glued to the single-faced corrugated cardboard sheet D, below the lower side portion of the belt 34 within the range of the heating section 20a. A plurality of (for example, ten to fifteen) of the heating plates 35, as illustrated in FIGS. 2 and 3, are provided along the movement direction of the belt 34. Additionally, as illustrated in FIG. 4, the heating plates 35 are provided with a larger width than the width of the double-faced corrugated cardboard sheet E along the width direction of the double-faced corrugated cardboard sheet E orthogonal to the movement direction of the belt 34. Each heating plate 35 is heated to a specified temperature by steam being supplied thereinto.

The pressing unit 4 is provided above the lower side portion of the belt 34 of the conveyance section 2. The pressing unit 4 has a plurality of pressing mechanism parts 4A. Each pressing mechanism part 4A has a pressing plate 4Aa provided to be capable of contacting an upper surface of the lower side portion of the belt 34, and a pressing applying mechanism 4Ab that supports the belt 34 with the pressing plate 4Aa so as to be capable of pressing the belt. The pressing applying mechanism 4Ab is constituted of an actuator. As the actuator, there are a power cylinder (a pneumatic cylinder, an oil hydraulic cylinder, a hydraulic cylinder, or an electric cylinder), a solenoid (electromagnetic valve), or the like. Additionally, the pressing applying mechanism 4Ab may be configured so that an elastic member, such as a spring, arranged between the actuator and the pressing plate 4Aa to apply an elastic force of the elastic member to the pressing plate 4Aa. Additionally, the belt 34 may be pressed using the pressing mechanism part 4A as an air bag. The plurality of pressing mechanism parts 4A are disposed in the movement direction of the belt 34 and in the width direction orthogonal to the movement direction, within a range of the heating section 20a. Each pressing mechanism part 4A applies a pressing force toward the heating section 3 side from above the belt 34 of the conveyance section 2. This pressing force is exerted by pressing the double-faced corrugated cardboard sheet E against the upper surface of the heating section 3 via the belt 34 of the conveyance section 2, thereby applying the frictional force of the belt 34 for moving the double-faced corrugated cardboard sheet E by means of the conveyance section 2, and is exerted by applying the heat for heating the double-faced corrugated cardboard sheet E by means of the heating section 3. In addition, in FIGS. 3 and 4, fourteen pressing mechanism parts 4A are provided in the movement direction and five pressing mechanism parts 4A are provided in the width direction. However, there is no limitation to this number.

The control unit 5 is connected so that the pressing applying mechanism 4Ab of each pressing mechanism part 4A can be separately controlled. That is, the control unit 5 separately controls the pressing force applied toward the heating section 3 side from above the belt 34 of the conveyance section 2 by each pressing mechanism part 4A.

Additionally, the device 1 for preventing warping of double-faced corrugated cardboard sheets may further include a warping information acquisition unit 6. The warping information acquisition unit 6, as illustrated in FIG. 3, is constituted as a warping form detection part 6a provided on the downstream side (the downstream side of the conveying belt 36 illustrated FIG. 2) of a cooling section 20b. The warping form detection part 6a detects the warping form of the double-faced corrugated cardboard sheet E after passing through the heating section 3 and the pressing unit 4, and includes a camera that detects the warping form from an image, an infrared sensor that detects the position of the upper surface (single facer side liner C side) of the double-faced corrugated cardboard sheet E, or the like. Warping form detection parts 6a are provided in a plurality of places along the width direction of the double-faced corrugated cardboard sheet E. Additionally, the warping information acquisition unit 6, as illustrated in FIG. 3, is constituted as a moisture state detection part 6b that is provided on the upstream side of the inlet portion where the single-faced corrugated cardboard sheet D and the double facer side liner A are carried into the heating section 20a. Moisture state detection parts 6b are provided corresponding to the single-faced corrugated cardboard sheet D and the double facer side liner A, respectively, so as to detect elements resulting from warping forms, and includes, for example moisture amount sensors that detect the moisture states of the single-faced corrugated cardboard sheet D and the double facer side liner A depending on the amount of moisture. Additionally, the moisture state detection parts 6b may estimate the moisture states of the single-faced corrugated cardboard sheet D and the double facer side liner A by the temperature detection sensors. Warping form detection parts 6b are provided in a plurality of places along the width direction of the double-faced corrugated cardboard sheet E. The warping information acquisition unit 6 is connected to the control unit 5 so that a detection result is input to the control unit 5. In addition, although the input of the detection result to the control unit 5 by the warping information acquisition unit 6 may be automatically performed, an operator may view the detection result of the warping information acquisition unit 6, and the operator may input the detection result to the control unit 5 with a keyboard, a mouse, or a touch panel.

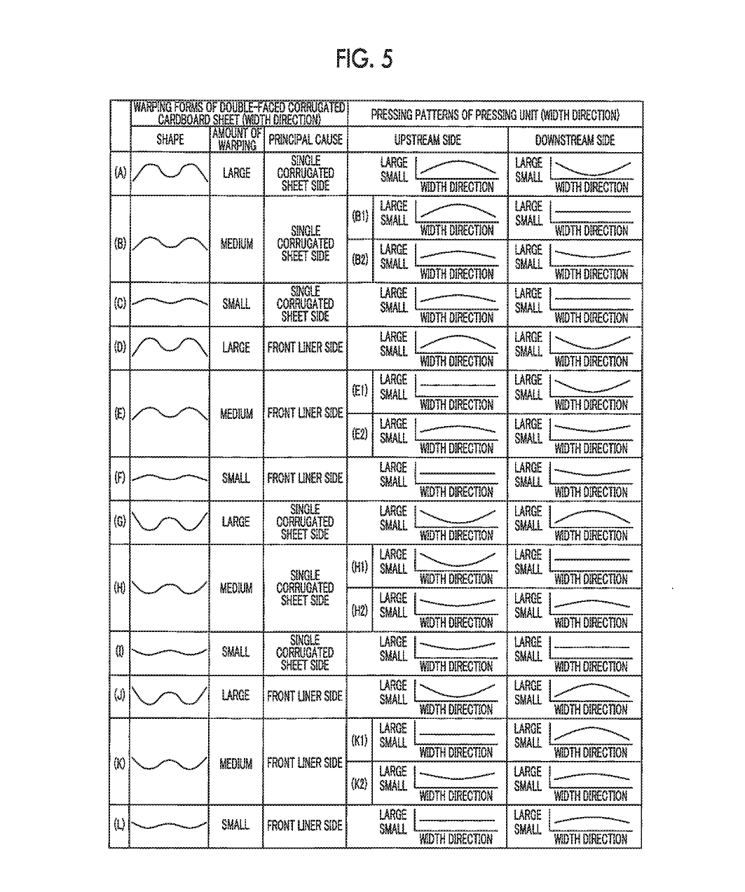

The control unit 5 controls the pressing mechanism parts 4A of the pressing unit 4 so as to provide a specified pressing pattern, on the basis of the input detection result and possible reasons of warping. FIG. 5 is a graph illustrating pressing patterns obtained by the device for preventing warping of double-faced corrugated cardboard sheets related to the present embodiment.

The possible reasons of warping will be described before the pressing patterns will be described. The possible reasons of warping vary depending on the shapes of the warping, respectively. Although reasons are generally well known regarding simple upward warping in the width direction (both ends of a corrugated cardboard sheet in its width direction is warped upward), simple downward warping (both ends of a corrugated cardboard sheet in its width direction is warped downward), and S-shaped warping (one end of a corrugated cardboard sheet in its width direction is warped upward and the other end thereof is warped downward), mechanical reasons are not found well regarding M-shaped warping (complex warping in which both ends of a corrugated cardboard sheet in its width direction are warped downward and a central part is warped upward), and W-shaped warping (complex warping in which both ends of a corrugated cardboard sheet in its width direction is warped upward and a central part is warped downward).

Next, the possible reasons of warping verified by the inventors will be described. Since the double facer side liner A side of the double-faced corrugated cardboard sheet E contacts an upper surface of the heating plate 35 of the heating section 3, the heat on the upper surface side of the heating plate 35 is deprived of by the double facer side liner A. Therefore, the temperature of the upper surface of the heating plate becomes lower than the lower side of the heating plate. As a result, both end sides of the heating plate tend to be deformed in U-shape so as to be lifted upward in the width direction. In the case of a mechanism in which the pressing unit 4 is not split or the pressing unit is split into the width direction but the amount of compression of a spring or the like varies in the width direction, due to deformation of the above heating plate 35, pressing of both ends of the double-faced corrugated cardboard sheet E in the width direction is largely exerted and pressing of the center of the double-faced corrugated cardboard sheet E in the width direction is a little exerted. Here, since the belt 34 contacting the single facer side liner C of the single-faced corrugated cardboard sheet D is strongly pressed against both the ends, in the width direction, of the double-faced corrugated cardboard sheet E on which pressing is largely exerted, the grip force of the belt 34 becomes large, and the force of pulling the single-faced corrugated cardboard sheet D in the movement direction becomes stronger as compared to the center of the single-faced corrugated cardboard sheet in the width direction. Then, in the single corrugated sheet heating roll 32, the winding force of both the ends of the single-faced corrugated cardboard sheet D in the width direction becomes stronger as compared to the center thereof, there is a tendency in which heating of both end portions of the single-faced corrugated cardboard sheet D increases and is further dried, and thereafter, both the end portions absorbs moisture and elongate relatively largely than the double facer side liner A side. Additionally, since the moisture of a central part of the single-faced corrugated cardboard sheet D is not deprived of as compared to both the end portions thereof, the subsequent elongation of the single-faced corrugated cardboard sheet tends to be relatively less than that of the double facer side liner A. For this reason, it has been elucidated that both the ends of the single-faced corrugated cardboard sheet D in the width direction is warped downward and the center thereof is warped upward, and the single-faced corrugated cardboard sheet D tries to assume an M-shape in a front view.

In addition, although the double facer side liner A is also heated by the double facer side liner heating roll 33, the glue that is not yet dried is interposed between the double facer side liner A immediately after being carried in between the heating section 3 and the pressing unit 4, and the single-faced corrugated cardboard sheet D. Therefore, the double facer side liner A has a low frictional coefficient and is apt to slip, and does not receive a larger pulling force than being exerted on the single-faced corrugated cardboard sheet D. Moreover, since the double facer side liner A contacts the heating plate 35 that is a fixed object, the pulling force is suppressed due to friction with the heating plate 35. Hence, even in a case where the heating plate 35 is deformed, pressing of both the ends of the double facer side liner in the width direction is largely exerted, and pressing of the center of the double facer side liner is a little exerted, a heating difference in the width direction does not easily occur in the heating roll 33, unlike the single-faced corrugated cardboard sheet D. Meanwhile, as the double facer side liner A contacting the heating plate 35, similar to the above, the heating plate 35 is deformed, pressing of both the ends of the double facer side liner in the width direction in the pressing unit 4 is largely exerted, and, pressing of the center of the double facer side liner in the width direction is a little exerted. Then, since both the ends, in the width direction, of the double facer side liner A on which pressing is largely exerted are heated, are deprived of moisture, and first contract, and thereafter absorb moisture and elongate, both the ends in the width direction is warped upward, the center is warped downward, and the double facer side liner tries to assume in a W-shape in a front view. That is, according to the inventors' verification, it has been elucidated that forms of warping exerted on the single-faced corrugated cardboard sheet D and the double facer side liner A are made reverse to each other. In this regard, when the double facer side liner A is glued to the single-faced corrugated cardboard sheet D and is made into the double-faced corrugated cardboard sheet E, warping of either the single-faced corrugated cardboard sheet D or the double facer side liner A becomes a larger warping form. In addition, if the warping of the single-faced corrugated cardboard sheet D and the warping of the double facer side liner A are equal, since the warping forms of the single-faced corrugated cardboard sheet D and the double facer side liner A are made reverse to each other. As a result, the double-faced corrugated cardboard sheet E with no warping by mutual cancellation is obtained.

In addition, in the above-described inventors' verification, an example in which the single-faced corrugated cardboard sheet D tries to assume an M-shape and the double facer side liner A tries to assume a W-shape has been described, but vice versa. For example, if deformation of the heating plate 35 of the heating section 3 is small and a crown with a large central diameter is present in the roller 34c on the downstream side of the roller 34a at the inlet portion, pressing forces are largely applied to the centers of the single-faced corrugated cardboard sheet D and the double facer side liner A in the width direction, contrary to the above-described exertion. Therefore, the single-faced corrugated cardboard sheet D tries to assume a W-shape, and the double facer side liner A tries to assume an M-shape.

Additionally, it has been elucidated by the inventors' verification that the warping on the single-faced corrugated cardboard sheet D side is easily exerted on the upstream side in the movement direction of the belt 34 near the inlet portion between the heating section 3 and the pressing unit 4. This is because the upstream side in the movement direction is closer to the single corrugated sheet heating roll 32, and therefore, the pulling force of the single-faced corrugated cardboard sheet D by the pressing force of the pressing unit 4 has a great influence on the winding forces of both ends of the single-faced corrugated cardboard sheet D in the width direction in the single corrugated sheet heating roll 32. Additionally, it has been elucidated by the inventors' verification that, since the exertion of warping on the single-faced corrugated cardboard sheet D is far from the single corrugated sheet heating roll 32 on the downstream side in the movement direction of the belt 34 between the heating section 3 and the pressing unit 4, and a pressing force is already applied on the upstream side, this becomes a hindrance, and the influence of the pulling force of the single-faced corrugated cardboard sheet D by the pressing force of the pressing unit 4 is not exerted on the single corrugated sheet heating roll 32 side. Meanwhile, there is no great difference in the exertion of warping on the double facer side liner A side from the upstream side to the downstream side between the heating section 3 and the pressing unit 4. In addition, the upstream side is a region near the inlet portion and the downstream side is a region far from the inlet portion. For example, there are regions obtained by dividing the movement direction of the belt 34 between the heating section 3 and the pressing unit 4 by the half, portions of regions obtained by dividing the movement direction by the half, regions obtained by further dividing upstream sides, which are obtained by dividing the movement direction of the belt 34 between the heating section 3 and the pressing unit 4 by the half, into two by the movement direction, regions obtained by dividing the movement direction of the belt 34 between the heating section 3 and the pressing unit 4 by a specified ratio into two, portions of regions obtained by dividing the movement direction into two by a specified ratio, regions obtained by further dividing upstream sides, which are obtained by dividing the movement direction of the belt 34 between the heating section 3 and the pressing unit 4 into two by a specified ratio, into two by the movement direction, or the like.

Therefore, in the present embodiment, with respect to the warping form of the double-faced corrugated cardboard sheet E, the respective pressing mechanism parts 4A are controlled in the control unit 5 so as to provide a pressing pattern to suppress occurrence of warping due to a relative difference between the exertion (the exertion in the single corrugated sheet heating roll 32) onto the single-faced corrugated cardboard sheet D and the exertion (the exertion in the heating plate 35) onto the double facer side liner A, on the upstream side in the movement direction of the belt 34, and a pressing pattern to suppress occurrence of warping in the exertion onto the double facer side liner A, on the downstream side in the movement direction of the belt 34.

Specifically, as warping forms other than general simple upward warping, simple downward warping, and S-shaped warping, mainly, as illustrated in FIG. 5, the double-faced corrugated cardboard sheet E has a form of being warped in an M-shape, and a form of being warped in a W-shape in the width direction. Additionally, in FIG. 5, the amounts of warping are divided roughly into large, medium, and small, and the principal reasons of warping are sorted depending on a single-faced corrugated cardboard sheet (single corrugated sheet side) or a double facer side liner (double facer side liner side). FIGS. 5(A) to 5(F) illustrate forms of being warped in an M-shape. Among them, FIGS. 5(A) to 5(C) illustrate that the principal reasons are single-faced corrugated cardboard sheets, FIG. 5(A) illustrates that the amount of warping is large, FIG. 5(B) illustrates that the amount of warping is medium, and FIG. 5(C) illustrates that the amount of warping is small. Additionally, FIGS. 5(D) to 5(F) illustrate that the principal reasons are double facer side liners, FIG. 5(D) illustrates that the amount of warping is large, FIG. 5(E) illustrates that the amount of warping is medium, and FIG. 5(F) illustrates that the amount of warping is small. Meanwhile, FIGS. 5(G) to 5(L) illustrate forms of being warped in a W-shape. Among them, FIGS. 5(G) to 5(I) illustrate that the principal reasons are single-faced corrugated cardboard sheets, FIG. 5(G) illustrates that the amount of warping is large, FIG. 5(H) illustrates that the amount of warping is medium, and FIG. 5(I) illustrates that the amount of warping is small. Additionally, FIGS. 5(J) to 5(L) illustrate that the principal reasons are double facer side liners, FIG. 5(J) illustrates that the amount of warping is large, FIG. 5(K) illustrates that the amount of warping is medium, and FIG. 5(L) illustrates that the amount of warping is small. In addition, the amounts of warping of the warping forms are detected by the warping form detection part 6a of the warping information acquisition unit 6. Otherwise, the amounts of warping may be determined by an operator. Additionally, the principal reasons are detected by the moisture state detection part 6b of the warping information acquisition unit 6.

As illustrated in FIGS. 5(A) to 5(C), in cases where the principal reasons of the forms of being warped in an M-shape are single-faced corrugated cardboard sheets, in FIG. 5(A) in which the amount of warping is large, the control unit 5 controls the pressing unit 4 so as to make the difference between pressing forces larger and make pressing forces on both end sides in the width direction smaller on the upstream side to make a pressing force at the center gradually larger, and controls the pressing unit 4 so as to make pressing forces on both end sides in the width direction larger on the downstream side to make a pressing force at the center gradually smaller. That is, the pressing patterns of the pressing forces in the width direction are made reverse to each other on the upstream side and the downstream side in the movement direction.

Additionally, in FIG. 5(B) in which the amount of warping is medium, the control unit 5 is set so as to select the pressing pattern of either (B1) or (B2). In (B1), the control unit 5 controls the pressing unit 4 so as to make the difference between pressing forces larger and make pressing forces on both end sides in the width direction smaller on the upstream side to make a pressing force at the center gradually larger, and controls the pressing unit 4 so as to make pressing forces in the width direction constant on the downstream side. Additionally, in (B2), the control unit 5 controls the pressing unit 4 so as to make the difference between pressing forces smaller and make pressing forces on both end sides in the width direction smaller on the upstream side to make a pressing force at the center gradually larger, and controls the pressing unit 4 so as to make pressing forces on both end sides in the width direction larger on the downstream side to make a pressing force at the center gradually smaller. That is, the pressing patterns of the pressing forces in the width direction are made reverse to each other on the upstream side and the downstream side in the movement direction.

Additionally, in FIG. 5(C) in which the amount of warping is small, the control unit 5 controls the pressing unit 4 so as to make the difference between pressing forces smaller and make pressing forces on both end sides in the width direction smaller on the upstream side to make a pressing force at the center gradually larger, and controls the pressing unit 4 so as to make pressing forces in the width direction constant on the downstream side.

As illustrated in FIGS. 5(D) to 5(F), in cases where the principal reasons of the forms of being warped in an M-shape are double facer side liners, in FIG. 5(D) where the amount of warping is large, the control unit 5 controls the pressing unit 4 so as to make the difference between pressing forces larger and make pressing forces on both end sides in the width direction smaller on the upstream side to make a pressing force at the center gradually larger, and controls the pressing unit 4 so as to make pressing forces on both end sides in the width direction larger on the downstream side to make a pressing force at the center gradually smaller. That is, the pressing patterns of the pressing forces in the width direction are made reverse to each other on the upstream side and the downstream side in the movement direction.

Additionally, in FIG. 5(E) in which the amount of warping is medium, the control unit 5 is set so as to select the pressing pattern of either (E1) or (E2). In (E1), the control unit 5 controls the pressing unit 4 so as to make pressing forces in the width direction constant on the upstream side, and controls the pressing unit 4 so as to make the difference between pressing forces larger and make pressing forces on both end sides in the width direction larger on the downstream side to make a pressing force at the center gradually smaller. Additionally, in (E2), the control unit 5 controls the pressing unit 4 so as to make the difference between pressing forces smaller and make pressing forces on both end sides in the width direction smaller on the upstream side to make a pressing force at the center gradually larger, and controls the pressing unit 4 so as to make pressing forces on both end sides in the width direction larger on the downstream side to make a pressing force at the center gradually smaller. That is, the pressing patterns of the pressing forces in the width direction are made reverse to each other on the upstream side and the downstream side in the movement direction.

Additionally, in FIG. 5(F) in which the amount of warping is small, the control unit 5 controls the pressing unit 4 so as to make pressing forces in the width direction constant on the upstream side, and controls the pressing unit 4 so as to make the difference between pressing forces smaller and make pressing forces on both end sides in the width direction larger on the downstream side to make a pressing force at the center gradually smaller.

In addition, in the warping forms of FIGS. 5(A) to 5(F), the pressing pattern may be set only by the amounts of warping regardless of the principal reasons. That is, the pressing patterns are set by the amounts of warping detected by the warping form detection part 6a of the warping information acquisition unit 6 or the amounts of warping determined by an operator. In cases where the amounts of warping are those in FIGS. 5(A) to 5(D), the control unit 5 controls the pressing unit 4 so as to make the difference between pressing forces larger and make pressing forces on both end sides in the width direction smaller on the upstream side to make a pressing force at the center gradually larger, and controls the pressing unit 4 so as to make pressing forces on both end sides in the width direction larger on the downstream side to make a pressing force at the center gradually smaller. Additionally, in cases where the amounts of warping are those in FIGS. 5(B) to 5(E), the control unit 5 controls the pressing unit 4 so as to make the difference between pressing forces smaller and make pressing forces on both end sides in the width direction smaller on the upstream side to make a pressing force at the center gradually larger, and controls the pressing unit 4 so as to make pressing forces on both end sides in the width direction larger on the downstream side to make a pressing force at the center gradually smaller. In addition, in cases where the amounts of warping are those in FIGS. 5(B) and 5(E) and warping still occurs, the control unit 5 makes on pressing force both end sides in the width direction constant on the upstream side or the downstream side. Additionally, in cases where the amounts of warping are those in FIGS. 5(C) to 5(F), the control unit 5 controls the pressing unit 4 so as to make the difference between pressing forces smaller and make pressing forces on both end sides in the width direction smaller on the upstream side to make a pressing force at the center gradually larger, and controls the pressing unit 4 so as to make pressing forces on both end sides in the width direction larger on the downstream side to make a pressing force at the center gradually smaller. In addition, in cases where the amounts of warping are those in FIGS. 5(C) and 5(F) and warping still occurs, the control unit 5 makes on pressing force both end sides in the width direction constant on the upstream side or the downstream side.

As illustrated in FIGS. 5(G) to 5(I), in cases where the principal reasons of the forms of being warped in a W-shape are single-faced corrugated cardboard sheets, in FIG. 5(G) in which the amount of warping is large, the control unit 5 controls the pressing unit 4 so as to make the difference between pressing forces larger and make pressing forces on both end sides in the width direction larger on the upstream side to make a pressing force at the center gradually smaller, and controls the pressing unit 4 so as to make pressing forces on both end sides in the width direction smaller on the downstream side to make a pressing force at the center gradually larger. That is, the pressing patterns of the pressing forces in the width direction are made reverse to each other on the upstream side and the downstream side in the movement direction.

Additionally, in FIG. 5(H) in which the amount of warping is medium, the control unit 5 is set so as to select the pressing pattern of either (H1) or (H2). In (H1), the control unit 5 controls the pressing unit 4 so as to make the difference between pressing forces larger and make pressing forces on both end sides in the width direction larger on the upstream side to make a pressing force at the center gradually smaller, and controls the pressing unit 4 so as to make pressing forces in the width direction constant on the downstream side. Additionally, in (H2), the control unit 5 controls the pressing unit 4 so as to make the difference between pressing forces smaller and make pressing forces on both end sides in the width direction larger on the upstream side to make a pressing force at the center gradually smaller, and controls the pressing unit 4 so as to make pressing forces on both end sides in the width direction smaller on the downstream side to make a pressing force at the center gradually larger. That is, the pressing patterns of the pressing forces in the width direction are made reverse to each other on the upstream side and the downstream side in the movement direction.

Additionally, in FIG. 5(I) in which the amount of warping is small, the control unit 5 controls the pressing unit 4 so as to make the difference between pressing forces smaller and make pressing forces on both end sides in the width direction larger on the upstream side to make a pressing force at the center gradually smaller, and controls the pressing unit 4 so as to make pressing forces in the width direction constant on the downstream side.

As illustrated in FIGS. 5(J) to 5(L), in cases where the principal reasons of the forms of being warped in a W-shape are double facer side liners, in FIG. 5(J) in which the amount of warping is large, the control unit 5 controls the pressing unit 4 so as to make the difference between pressing forces larger and make pressing forces on both end sides in the width direction larger on the upstream side to make a pressing force at the center gradually smaller, and controls the pressing unit 4 so as to make pressing forces on both end sides in the width direction smaller on the downstream side to make a pressing force at the center gradually larger. That is, the pressing patterns of the pressing forces in the width direction are made reverse to each other on the upstream side and the downstream side in the movement direction.

Additionally, in FIG. 5(K) in which the amount of warping is medium, the control unit 5 is set so as to select the pressing pattern of either (K1) or (K2). In (K1), the control unit 5 controls the pressing unit 4 so as to make pressing forces in the width direction constant on the upstream side, and controls the pressing unit 4 so as to make the difference between pressing forces larger and make pressing forces on both end sides in the width direction smaller on the downstream side to make a pressing force at the center gradually larger. Additionally, in (K2), the control unit 5 controls the pressing unit 4 so as to make the difference between pressing forces smaller and make pressing forces on both end sides in the width direction larger on the upstream side to make a pressing force at the center gradually smaller, and controls the pressing unit 4 so as to make pressing forces on both end sides in the width direction smaller on the downstream side to make a pressing force at the center gradually larger. That is, the pressing patterns of the pressing forces in the width direction are made reverse to each other on the upstream side and the downstream side in the movement direction.

Additionally, in FIG. 5(L) in which the amount of warping is small, the control unit 5 controls the pressing unit 4 so as to make pressing forces in the width direction constant on the upstream side, and controls the pressing unit 4 so as to make the difference between pressing forces smaller and make pressing forces on both end sides in the width direction smaller on the downstream side to make a pressing force at the center gradually larger.

In addition, in the warping forms of FIGS. 5(G) to 5(L), the pressing pattern may be set only by the amounts of warping regardless of the principal reasons. That is, the pressing patterns are set by the amounts of warping detected by the warping form detection part 6a of the warping information acquisition unit 6 or the amounts of warping determined by an operator. In cases where the amounts of warping are those in FIGS. 5(G) to 5(J), the control unit 5 controls the pressing unit 4 so as to make the difference between pressing forces larger and make pressing forces on both end sides in the width direction larger on the upstream side to make a pressing force at the center gradually smaller, and controls the pressing unit 4 so as to make pressing forces on both end sides in the width direction smaller on the downstream side to make a pressing force at the center gradually larger. Additionally, in cases where the amounts of warping are those in FIGS. 5(H) to 5(K), the control unit 5 controls the pressing unit 4 so as to make the difference between pressing forces smaller and make pressing forces on both end sides in the width direction larger on the upstream side to make a pressing force at the center gradually small, and controls the pressing unit 4 so as to make pressing forces on both end sides in the width direction smaller on the downstream side to make a pressing force at the center gradually larger. In addition, in cases where the amounts of warping are those in FIGS. 5(H) and 5(K) and warping still occurs, the control unit 5 makes on pressing force both end sides in the width direction constant on the upstream side or the downstream side. Additionally, in cases where the amounts of warping are those in FIGS. 5(I) to 5(L), the control unit 5 controls the pressing unit 4 so as to make the difference between pressing forces smaller and make pressing forces on both end sides in the width direction larger on the upstream side to make a pressing force at the center gradually small, and controls the pressing unit 4 so as to make pressing forces on both end sides in the width direction smaller on the downstream side to make a pressing force at the center gradually larger. In addition, in cases where the amounts of warping are those in FIGS. 5(I) and 5(L) and warping still occurs, the control unit 5 makes on pressing force both end sides in the width direction constant on the upstream side or the downstream side.

As described above, the device 1 for preventing warping of double-faced corrugated cardboard sheets of the present embodiment includes the conveyance section 2 for moving the belt 34 in a specified direction while bringing the belt 34 into contact with the upper surface of the single-faced corrugated cardboard sheet D when manufacturing the double-faced corrugated cardboard sheet E by gluing the single-faced corrugated cardboard sheet D, including the corrugated medium B and the single facer side liner C, to the double facer side liner A (first liner); the heating section 3 that is provided below the conveyance section 2 and contacts the lower surface of the double facer side liner A; a pressing unit 4 having a plurality of pressing mechanism parts 4A that are disposed in the movement direction of the belt 34 and the width direction orthogonal to the movement direction above the belt 34 of the conveyance section 2 and apply pressing forces toward the heating section 3 via the belt 34 of the conveyance section 2; and a control unit 5 that controls the respective pressing mechanism parts 4A of the pressing units 4 so that the assignment (pressing patterns) of the pressing forces in the width direction is made different on the upstream side and the downstream side in the movement direction of the belt 34.

It has been elucidated by the inventors' verification that the forms of warping exerted on the single-faced corrugated cardboard sheet D and the double facer side liner A, respectively, in the double-faced corrugated cardboard sheet E, are made reverse to each other on the upstream side and the downstream side in the movement direction of the belt 34. According to the device 1 for preventing warping of double-faced corrugated cardboard sheets, with respect to the warping forms of the double-faced corrugated cardboard sheet E, warping that occurs in the double-faced corrugated cardboard sheet E can be effectively prevented by controlling the respective pressing mechanism parts 4A in the control unit 5 so as to provide pressing patterns such that occurrence of warping of the single-faced corrugated cardboard sheet D and the double facer side liner A is prevented on the upstream side and the downstream side, respectively, in the movement direction of the belt 34.

Additionally, the device 1 for preventing warping of double-faced corrugated cardboard sheets of the present embodiment includes the warping information acquisition unit 6 that acquires warping information including a warping form in the width direction of the double-faced corrugated cardboard sheet E or element resulting from the warping form, and the control unit 5 controls the respective pressing mechanism parts 4A of the pressing unit 4, on the basis of the warping information input from the warping information acquisition unit 6.

According to the device 1 for preventing warping of double-faced corrugated cardboard sheets, warping that occurs in the double-faced corrugated cardboard sheet E can be more effectively prevented by inputting the warping information including the warping form or the element resulting from the warping form to the control unit 5.

Additionally, the method for preventing warping of double-faced corrugated cardboard sheets of the present embodiment includes a conveying step of moving the belt 34 in a specified direction while bringing the belt 34 into contact with the upper surface of the single-faced corrugated cardboard sheet D when manufacturing the double-faced corrugated cardboard sheet E by gluing the single-faced corrugated cardboard sheet D, including the corrugated medium B and the single facer side liner (second liner) C, to the double facer side liner (first liner) A; a heating step of performing heating from the lower surface side of the double facer side liner A of the double-faced corrugated cardboard sheet E moved by the conveying step; and a pressing step of applying pressing forces to the double-faced corrugated cardboard sheet E moved by the conveying step from the single-faced corrugated cardboard sheet D side via the belt 34, and making assignment (pressing patterns) of the pressing forces in the width direction different on the upstream side and the downstream side in the movement direction of the belt 34.

It has been elucidated by the inventors' verification that the forms of warping exerted on the single-faced corrugated cardboard sheet D and the double facer side liner A, respectively, in the double-faced corrugated cardboard sheet E, are made reverse to each other on the upstream side and the downstream side in the movement direction of the belt 34. According to the method for preventing warping of double-faced corrugated cardboard sheets, with respect to the warping forms of the double-faced corrugated cardboard sheet E, warping that occurs in the double-faced corrugated cardboard sheet E can be effectively prevented by providing pressing patterns such that occurrence of warping of the single-faced corrugated cardboard sheet D and the double facer side liner A is prevented on the upstream side and the downstream side, respectively, in the movement direction of the belt 34.

Additionally, in the method for preventing warping of double-faced corrugated cardboard sheets of the present embodiment, the assignment positions of the pressing forces in the width direction are made reverse to each other on the upstream side and the downstream side in the movement direction of the belt 34 in the pressing step.

According to the method for preventing warping of double-faced corrugated cardboard sheets, for example, in a case where warping is exerted on both of the single-faced corrugated cardboard sheet D and the double facer side liner A, the assignment positions of the pressing forces in the width direction are made reverse to each other on the upstream side and the downstream side in the movement direction of the belt 34, so that both kinds of the warping can be suppressed and warping that occurs in the double-faced corrugated cardboard sheet E can be effectively prevented.

Additionally, in the method for preventing warping of double-faced corrugated cardboard sheets of the present embodiment, in the pressing step, the pressing forces in the width direction are made different on the upstream side in the movement direction of the belt 34 and the pressing forces in the width direction are made constant on the downstream side.

According to the method for preventing warping of double-faced corrugated cardboard sheets, for example, in a case where the amount of warping is relatively small and warping is markedly exerted on one of the single-faced corrugated cardboard sheet D and the double facer side liner A, the pressing forces in the width direction are made different on the upstream side in the movement direction of the belt 34 and the pressing forces in the width direction are made constant on the downstream side, so that warping that is marked exerted can be suppressed and warping that occurs in the double-faced corrugated cardboard sheet E can be effectively prevented.

Additionally, in the method for preventing warping of double-faced corrugated cardboard sheets of the present embodiment, in the pressing step, the pressing forces in the width direction are made different on the downstream side in the movement direction of the belt 34 and the pressing forces in the width direction on the upstream side are made constant.

According to the method for preventing warping of double-faced corrugated cardboard sheets, for example, in a case where the amount of warping is relatively small and warping is markedly exerted on one of the single-faced corrugated cardboard sheet D and the double facer side liner A, the pressing forces in the width direction are made different on the upstream side in the movement direction of the belt 34 and the pressing forces in the width direction are made constant on the downstream side, so that warping that is marked exerted can be suppressed and warping that occurs in the double-faced corrugated cardboard sheet E can be effectively prevented.

Additionally, in the method for preventing warping of double-faced corrugated cardboard sheets of the present embodiment, in the pressing step, the warping information including the warping form in the width direction of the double-faced corrugated cardboard sheet E or the element resulting from the warping form is acquired, and the pressing forces are applied on the basis of the warping information.

According to the method for preventing warping of double-faced corrugated cardboard sheets, warping that occurs in the double-faced corrugated cardboard sheet E can be more effectively prevented by acquiring the warping information including the warping form or the element resulting from the warping form.

Additionally, the corrugating machine (manufacturing apparatus for double-faced corrugated cardboard sheets) 10 of the present embodiment is the corrugating machine 10 that glues the single facer side liner (second liner) C to the corrugated medium B to form the single-faced corrugated cardboard sheet D, and subsequently, glues the double facer side liner (first liner) A to the corrugated medium B in the single-faced corrugated cardboard sheet D to form the double-faced corrugated cardboard sheet E. The above-described device 1 for preventing warping of double-faced corrugated cardboard sheets is applied to this corrugating machine in a case where the double facer side liner A in the single-faced corrugated cardboard sheet D is glued to the corrugated medium B.

According to the corrugating machine 10, with respect to the warping forms of the double-faced corrugated cardboard sheet E, warping that occurs in the double-faced corrugated cardboard sheet E can be effectively prevented by controlling the respective pressing mechanism parts 4A in the control unit 5 so as to provide pressing patterns such that occurrence of warping of the single-faced corrugated cardboard sheet D and the double facer side liner A is prevented on the upstream side and the downstream side, respectively, in the movement direction of the belt 34. As a result, the number of defects in which the double-faced corrugated cardboard sheet E is warped can be reduced.

### REFERENCE SIGNS LIST

1: DEVICE FOR PREVENTING WARPING OF DOUBLE-FACED CORRUGATED CARDBOARD SHEETS

2: CONVEYANCE SECTION

3: HEATING SECTION

4: PRESSING UNIT

4A: PRESSING MECHANISM PART

5: CONTROL UNIT

6: INFORMATION ACQUISITION UNIT

10: CORRUGATING MACHINE (MANUFACTURING APPARATUS FOR DOUBLE-FACED CORRUGATED CARDBOARD SHEETS)

34: BELT

35: HEATING PLATE

A: DOUBLE FACER SIDE LINER

B: CORRUGATED MEDIUM

C: SINGLE FACER SIDE LINER

D: SINGLE-FACED CORRUGATED CARDBOARD SHEET

E: DOUBLE-FACED CORRUGATED CARDBOARD SHEET

1. A device for preventing warping of doubled-faced corrugated cardboard sheets, comprising:
a conveyance section for moving a belt in a specified direction while bringing the belt into contact with an upper surface of a single-faced corrugated cardboard sheet when manufacturing a double-faced corrugated cardboard sheet by gluing the single-faced corrugated cardboard sheet including a corrugated medium and a second liner to a first liner;
a heating section that is provided below the conveyance section and contacts a lower surface of the first liner;
a pressing unit having a plurality of pressing mechanism parts that are disposed in a movement direction of the belt and a width direction orthogonal to the movement direction and apply pressing forces toward the heating section via the belt of the conveyance section; and
a control unit that controls the respective pressing mechanism parts of the pressing unit so that the pressing forces in the width direction are differently assigned on an upstream side and a downstream side in the movement direction of the belt.

2. The device for preventing warping of double-faced corrugated cardboard sheets according to claim 1, further comprising:
a warping information acquisition unit that acquires warping information including a warping form in the width direction of the double-faced corrugated cardboard sheet or an element resulting from the warping form,
wherein the control unit controls the respective pressing mechanism parts of the pressing unit, on the basis of the warping information input from the warping information acquisition unit.

3. A method for preventing warping of double-faced corrugated cardboard sheets, comprising:
a conveying step of moving a belt in a specified direction while bringing the belt into contact with an upper surface of a single-faced corrugated cardboard sheet when manufacturing a double-faced corrugated cardboard sheet by gluing the single-faced corrugated cardboard sheet including a corrugated medium and a second liner, to a first liner;
a heating step of performing heating from a lower surface side of the first liner of the double-faced corrugated cardboard sheet moved by the conveying step; and
a pressing step of applying pressing forces to the double-faced corrugated cardboard sheet moved by the conveying step from the single-faced corrugated cardboard sheet side via the belt, and making assignment of the pressing forces in the width direction different on an upstream side and a downstream side in the movement direction of the belt.

4. The method for preventing warping of double-faced corrugated cardboard sheets according to claim 3,
wherein the assignment positions of the pressing forces in the width direction are made reverse to each other on the upstream side and the downstream side in the movement direction of the belt in the pressing step.

5. The method for preventing warping of double-faced corrugated cardboard sheets according to claim 3,
wherein, in the pressing step, the pressing forces in the width direction are made different on the upstream side in the movement direction of the belt and the pressing forces in the width direction are made constant on the downstream side.

6. The method for preventing warping of double-faced corrugated cardboard sheets according to claim 3,
wherein, in the pressing step, the pressing forces in the width direction are made different on the downstream side in the movement direction of the belt and the pressing forces in the width direction are made constant on the upstream side.

7. The method for preventing warping of double-faced corrugated cardboard sheets according to claim 3,
wherein, in the pressing step, warping information including a warping form in the width direction of the double-faced corrugated cardboard sheet or an element resulting from the warping form is acquired, and the pressing forces are applied on the basis of the warping information.

8. A manufacturing apparatus for double-faced corrugated cardboard sheets that glues a second liner to a corrugated medium to form a single-faced corrugated cardboard sheet, and subsequently, glues the first liner to the corrugated medium in the single-faced corrugated cardboard sheet to a form double-faced corrugated cardboard sheet,
wherein the device for preventing warping of double-faced corrugated cardboard sheets according to claim 1 is applied in a case where the first liner in the single-faced corrugated cardboard sheet is glued to the corrugated medium.
